(19) United States
(12) Patent Application Publication
(10) Pub. No.: US 2017/0204257 A1
(43) Pub. Date: Jul. 20, 2017

(54) TIRE WITH LOW ROLLING RESISTANCE

(71) Applicants: COMPAGNIE GENERALE DES ETABLISSEMENTS MICHELIN, Clermont-Ferrand (FR); Michelin Recherche et Technique S.A., GRANGES-PACCOT (CH)

(72) Inventors: PHILIPPE LABRUNIE, CLERMONT-FERRAND (FR); BENOIT DE GAUDEMARIS, CLERMONT-FERRAND (FR)

(21) Appl. No.: 15/315,609

(22) PCT Filed: May 27, 2015
(86) PCT No.: PCT/EP2015/061627

§ 371 Date: Dec. 1, 2016

(30) Foreign Application Priority Data
Jun. 5, 2014 (FR) 1455097

(51) Int. Cl. C08L 9/06; B29D 30/06; B29B 7/82; B60C 1/00; B29C 43/00; B29C 43/24; B29C 47/00; B29D 30/00; B29B 7/90

(52) U.S. Cl. CPC C08L 9/06; B29D 30/0005; B29D 30/06; B29B 7/82; B29B 7/90; B29C 43/003; B29C 43/24; B29C 47/0004; B60C 1/0016; B29K 2009/06

(57) ABSTRACT

A tire tread comprises a rubber composition based on at least: an elastomer matrix comprising more than 50% by weight of a solution SBR bearing a silanol function at the chain end, a reinforcing filler present at a content of between 40 and 80 phr, which reinforcing filler comprises between 40 and 80 phr of a silica, a coupling agent for coupling the silica to the solution SBR, 10 to 50 phr of a hydrocarbon-based resin having a Tg of greater than 20° C., and 0 to less than 5 phr of a liquid plasticizer. Such a tire has a good performance compromise between rolling resistance and grip.

The field of the invention is that of tyres with low rolling resistance.

A tyre has to meet, in a known way, a large number of often conflicting technical requirements, including low rolling resistance, high wear resistance, high dry grip and high wet grip.

This compromise in properties, in particular from the viewpoint of rolling resistance and wear resistance, has been able to be improved in recent years with regard to energy-saving “Green Tyres”, intended especially for passenger vehicles, by virtue especially of the use, as tread, of novel low hysteresis rubber compositions having the feature of being predominantly reinforced by specific inorganic fillers, described as reinforcing fillers, especially by highly dispersible silicas (HDSs), capable of rivalling, from the viewpoint of reinforcing power, conventional tyre-grade carbon blacks.

Tyre treads with low rolling resistance may be obtained by the combined use of silica and functional elastomers, the function of which interacts with the silica. Mention may be made, by way of example, of the patents or patent applications EP 0 778 311 B1, EP 0877 047 B1, WO 2008/141702 and WO 2006/050486. To improve the low rolling resistance performance of the tyre even further, it is possible to reduce the content of reinforcing filler, especially of silica, in the rubber composition of the tread. However, this solution generally has the drawback of reducing the grip performance of the tyre.

Moreover, it is known that the grip performance of a tyre may be improved by increasing the surface area of contact of the tread on the ground on which the tyre is running, especially by using a deformable material as tread, in this instance a deformable rubber composition. One way to make a rubber composition more deformable is to make it even softer by introducing a large amount of plasticizer. Nonetheless, this solution may encounter the problem of exudation of plasticizer when the amounts of plasticizer are relatively large.

The applicants have found a solution to this problem by specifically combining, in a rubber composition for a tread reinforced by a silica, a certain elastomer matrix, a determined content of reinforcing filler and a particular plasticizing system.

Thus, a subject-matter of the invention is a tyre tread which comprises a rubber composition based on at least:
an elastomer matrix comprising more than 50% by weight of a solution SBR bearing a silanol function at the chain end,
a reinforcing filler present at a content of between 40 phr and 80 phr, which reinforcing filler comprises between 40 and 80 phr of a silica,
a coupling agent for coupling the silica to the solution SBR,
10 to 50 phr of a hydrocarbon-based resin having a Tg of greater than 20° C.,
0 to less than 5 phr of a liquid plasticizer.

Another subject of the invention is a process for the tyre in accordance with the invention.

The tyres of the invention are particularly intended to equip motor vehicles of passenger type, and also two-wheel vehicles.

The invention and its advantages will be readily understood in the light of the description and the exemplary embodiments that follow.

### I—DETAILED DESCRIPTION OF THE INVENTION

In the present description, unless expressly indicated otherwise, all the percentages (%) shown are % by weight. The abbreviation “phr” means parts by weight per hundred parts of the elastomer matrix, which consists of all the elastomers present in the rubber composition. All the values for glass transition temperature “Tg” are measured in a known manner by DSC (Differential Scanning Calorimetry) according to Standard ASTM D3418 (1999).

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### I-1. Elastomer Matrix:

The solution SBR is a copolymer of butadiene and styrene, prepared in solution. The essential feature thereof is that it bears a silanol function at the chain end.

An elastomer of this type may be prepared according to the procedure described in patent EP 0 778 311 B1, for example by reaction of the carbanion at the end of the living elastomer chain with hexamethylcyclotrisiloxane, followed by reaction with a proton donor.

It is understood that the solution SBR may consist of a mixture of solution SBR, the solution SBRs being differentiated from one another by their microstructure or by their macrostructure.

According to any one of the embodiments of the invention, the solution SBR preferably has a glass transition temperature of less than −40° C., more preferentially of between −70° C. and −40° C.

When the elastomer matrix of the composition of the tread in accordance with the invention comprises a second elastomer, this second elastomer is preferably a diene elastomer.

A “diene” elastomer (or “rubber”, the two terms being considered to be synonymous) should be understood, in a known way, to mean an (one or more is understood) elastomer resulting at least in part (i.e., a homopolymer or a copolymer) from diene monomers (monomers bearing two carbon-carbon double bonds which may or may not be conjugated).

These diene elastomers can be classified into two categories: “essentially unsaturated” or “essentially saturated”. Generally, “essentially unsaturated” is intended to mean a diene elastomer resulting at least in part from conjugated diene monomers having a content of units of diene origin (conjugated dienes) which is greater than 15% (mol %); thus, diene elastomers, such as butyl rubbers or copolymers of dienes and α-olefins of EPDM type, do not fall under the preceding definition and may especially be described as “essentially saturated” diene elastomers (low or very low content, always less than 15%, of units of diene origin). In the category of “essentially unsaturated” diene elastomers, a “highly unsaturated” diene elastomer is intended in particular to mean a diene elastomer having a content of units of diene origin (conjugated dienes) which is greater than 50%.

Although it applies to any type of diene elastomer, those skilled in the art of tyres will understand that the invention is preferably carried out with essentially unsaturated diene elastomers.

Given these definitions, the expression diene elastomer capable of being used in the compositions in accordance with the invention is intended especially to mean:
(a)—any homopolymer obtained by polymerization of a conjugated diene monomer, preferably having from 4 to 12 carbon atoms;
(b)—any copolymer obtained by copolymerization of one or more conjugated dienes with one another or with one or more vinylaromatic compounds preferably having from 8 to 20 carbon atoms.

The following are especially suitable as conjugated dienes: 1,3-butadiene, 2-methyl-1,3-butadiene, 2,3-di(C1-C5 alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The second elastomer, when it is a diene elastomer, is different from the solution SBR in that it does not bear a silanol function at the chain end. Nevertheless, it may have a microstructure or a macrostructure that may be identical to or different from those of the solution SBR.

The second elastomer, whether a diene elastomer or not, is used in a proportion of between 0 and 50%, preferentially between 0 and 25%, more preferentially between 0 and 10% of the weight of the elastomer matrix. In other words, the elastomer matrix comprises more than 50%, preferentially more than 75% solution, even more preferentially more than 90% by weight of the solution SBR, the remainder to 100% consisting of the second elastomer. These preferential ranges apply to any one of the embodiments of the invention.

The second diene elastomer is selected from the group consisting of polybutadienes, natural rubber, synthetic polyisoprenes, butadiene copolymers, isoprene copolymers and mixtures of these elastomers.

### I-2. Reinforcing Filler

The rubber composition comprises any type of “reinforcing” filler known for its abilities to reinforce a rubber composition which can be used for the manufacture of a tyre tread. The content of reinforcing filler is greater than 40 phr and less than or equal to 80 phr.

Such a reinforcing filler typically consists of nanoparticles, the (weight-)average size of which is less than a micrometre, generally less than 500 nm, usually between 20 and 200 nm, in particular and more preferentially between 20 and 150 nm.

The reinforcing filler has the essential feature of comprising between 40 and 80 phr of a silica.

The silica used can be any reinforcing silica known to those skilled in the art, especially any precipitated or fumed silica having a BET surface area and a CTAB specific surface area both of less than 450 m2/g, preferably from 30 to 400 m2/g, especially between 60 and 300 m2/g. As highly dispersible precipitated silicas (“HDSs”), mention will be made, for example, of the “Ultrasil” 7000 and “Ultrasil” 7005 silicas from Degussa, the “Zeosil” 1165MP, 1135MP and 1115MP silicas from Rhodia, the “Hi-Sil” EZ150G silica from PPG, the “Zeopol” 8715, 8745 and 8755 silicas from Huber and the silicas having a high specific surface area as described in application WO 03/16387.

Those skilled in the art will understand that, as filler equivalent to silica described in the present paragraph, use may be made of a reinforcing filler of another kind, especially an organic filler such as carbon black, as long as this reinforcing filler is covered with a silica. By way of example, mention may be made, for example, of carbon blacks for tyres, such as described, for example, in patent documents WO 96/37547 and WO 99/28380.

According to a particular embodiment of the invention, the content of silica is within a range extending from 50 to 70 phr. According to this particular embodiment of the invention, the content of reinforcing filler preferentially varies between 50 and 75 phr, more preferentially between 55 and 70 phr.

According to one embodiment of the invention, the rubber composition may comprise carbon black. All carbon blacks, especially the blacks conventionally used in tyres or their treads (“tyre-grade” blacks), are suitable as carbon blacks. Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 and N772 blacks. These carbon blacks may be used on their own, as available commercially, or in any other form, for example as support for some of the rubber-making additives used.

The carbon black, when present, is preferably used at a content of less than 10 phr, more preferentially less than or equal to 5 phr. These preferential ranges apply to any one of the embodiments of the invention. Within the intervals indicated, the colouring properties (black pigmenting agent) and UV-stabilizing properties of the carbon blacks are beneficial, without, moreover, adversely affecting the typical performance properties contributed by the reinforcing inorganic filler.

As is well known, use is made of a coupling agent (or bonding agent), generally a silane, intended to provide a satisfactory chemical and/or physical connection between the silica (surface of the particles thereof) and one of the elastomers of the elastomer matrix, especially the solution SBR. This coupling agent is at least bifunctional. Use is made in particular of at least bifunctional organosilanes or polyorganosiloxanes.

Use is made especially of silane polysulphides, referred to as “symmetrical” or “asymmetrical” depending on their specific structure, such as described, for example, in applications WO 03/002648 (or US 2005/016651) and WO 03/002649 (or US 2005/016650).

Particularly suitable, without the definition below being limiting, are silane polysulphides corresponding to the following general formula (I):

Z-A-Sx-A-Z, (I)

in which:
x is an integer from 2 to 8 (preferably from 2 to 5);
the A symbols, which are identical or different, represent a divalent hydrocarbon radical (preferably a C1-C18 alkylene group or a C6-C12 arylene group, more particularly a C1-C10, in particular C1-C4, alkylene, especially propylene);
the Z symbols, which are identical or different, correspond to one of the three formulae below:

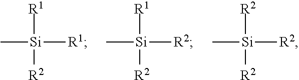

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferentially still a group chosen from C₁-C₄ alkoxyls, in particular methoxyl and ethoxyl).

In the case of a mixture of alkoxysilane polysulphides corresponding to the above formula (I), especially customary commercially available mixtures, the mean value of “x” is a fractional number preferably of between 2 and 5, more preferentially close to 4. However, the invention may also be advantageously carried out, for example, with alkoxysilane disulphides (x=2).

Mention will more particularly be made, as examples of silane polysulphides, of bis((C₁-C₄)alkoxyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂. Mention will also be made, as preferential examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, such as described in the abovementioned patent application WO 02/083782 (or U.S. Pat. No. 7,217,751).

Mention will in particular be made, as examples of coupling agents other than an alkoxysilane polysulphide, of bifunctional POSs (polyorganosiloxanes) or else of hydroxysilane polysulphides (R2=OH in the above formula I), such as described, for example, in patent applications WO 02/30939 (or U.S. Pat. No. 6,774,255), WO 02/31041 (or US 2004/051210) and WO 2007/061550, or else of silanes or POSs bearing azodicarbonyl functional groups, such as described, for example, in patent applications WO 2006/125532, WO 2006/125533 and WO 2006/125534.

Mention will be made, as examples of other silane sulphides, for example, of silanes bearing at least one thiol (—SH) function (referred to as mercaptosilanes) and/or at least one masked thiol function, such as described, for example, in patents or patent applications U.S. Pat. No. 6,849,754, WO 99/09036, WO 2006/023815 and WO 2007/098080.

Of course, use might also be made of mixtures of the coupling agents described above, as described in particular in the abovementioned application WO 2006/125534.

The content of coupling agent is advantageously less than 10 phr, it being understood that it is generally desirable to use as little as possible thereof. The content thereof is preferentially between 0.5 and 8 phr, more preferentially between 2 and 8 phr. This content is easily adjusted by those skilled in the art depending on the content of silica used in the composition.

### I-3. Hydrocarbon-Based Resin:

The hydrocarbon-based resin, present in the rubber composition at a content ranging from 10 to 50 phr, has a glass transition temperature Tg of greater than 20° C.

The designation “resin” is reserved in the present application, by definition known to those skilled in the art, for a compound which is solid at room temperature (23° C.), in contrast to a liquid plasticizer such as an oil.

Hydrocarbon-based resins are polymers well known to those skilled in the art, essentially based on carbon and hydrogen but being able to comprise other types of atoms, which can be used in particular as plasticizers or tackifiers in polymer matrices. They are by nature miscible (i.e., compatible) at the contents used with the polymer compositions for which they are intended, so as to act as true diluents. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, especially in the tyre rubber field (5.5. “Rubber Tires and Mechanical Goods”). They may be aliphatic, cycloaliphatic, aromatic, hydrogenated aromatic, or of the aliphatic/aromatic type, that is to say based on aliphatic and/or aromatic monomers. They may be natural or synthetic and may or may not be based on petroleum (if this is the case, they are also known under the name of petroleum resins). Their Tg is preferably greater than 0° C., especially greater than 20° C. (generally between 30° C. and 95° C.).

In a known way, these hydrocarbon-based resins can also be described as thermoplastic resins in the sense that they soften when heated and can thus be moulded. They may also be defined by a softening point or temperature. The softening point of a hydrocarbon-based resin is generally greater by approximately 50 to 60° C. than its Tg value. The softening point is measured according to Standard ISO 4625 (ring and ball method). The macrostructure (Mw, Mn and PI) is determined by size exclusion chromatography (SEC) as indicated below.

As a reminder, the SEC analysis, for example, consists in separating the macromolecules in solution according to their size through columns filled with a porous gel; the molecules are separated according to their hydrodynamic volume, the bulkiest being eluted first. The sample to be analysed is simply dissolved beforehand in an appropriate solvent, tetrahydrofuran, at a concentration of 1 g/litre. The solution is then filtered through a filter with a porosity of 0.45 μm, before injection into the apparatus. The apparatus used is, for example, a “Waters Alliance” chromatographic line according to the following conditions:
elution solvent: tetrahydrofuran;
temperature: 35° C.;
concentration: 1 g/litre;
flow rate: 1 ml/min;
injected volume: 100 μl;
Moore calibration with polystyrene standards;
set of 3 “Waters” columns in series (Styragel HR4E, Styragel HR1 and Styragel HR 0.5);
detection by differential refractometer (for example WATERS 2410) which may be equipped with operating software (for example Waters Millenium).

A Moore calibration is carried out with a series of commercial polystyrene standards having a low PI (less than 1.2), with known molar masses, covering the range of masses to be analysed. The weight-average molar mass (Mw), the number-average molar mass (Mn) and the polydispersity index (PI=Mw/Mn) are deduced from the data recorded (curve of distribution by mass of the molar masses).

All the values for molar masses shown in the present patent application are thus relative to calibration curves produced with polystyrene standards.

According to a preferred embodiment of the invention, the hydrocarbon-based resin has at least any one, more preferentially all, of the following characteristics:
a Tg of greater than 25° C. (in particular between 30° C. and 100° C.), more preferentially of greater than 30° C. (in particular between 30° C. and 95° C.);
a softening point of greater than 50° C. (in particular between 50° C. and 150° C.);
a number-average molar mass (Mn) of between 400 and 2000 g/mol, preferentially between 500 and 1500 g/mol;
a polydispersity index (PI) of less than 3, preferentially of less than 2 (as a reminder: PI=Mw/Mn with Mw the weight-average molar mass).

Mention may be made, as examples of such hydrocarbon-based resins, of cyclopentadiene (abbreviated to CPD) homopolymer or copolymer resins, dicyclopentadiene (abbreviated to DCPD) homopolymer or copolymer resins, terpene homopolymer or copolymer resins, C5 fraction homopolymer or copolymer resins, C9 fraction homopolymer or copolymer resins, α-methylstyrene homopolymer or copolymer resins or mixtures of these resins. Mention may more particularly be made, among the above copolymer resins, of (D)CPD/vinylaromatic copolymer resins, (D)CPD/terpene copolymer resins, terpene/phenol copolymer resins, (D)CPD/C5 fraction copolymer resins, (D)CPD/C9 fraction copolymer resins, terpene/vinylaromatic copolymer resins, terpene/phenol copolymer resins, C5 fraction/vinylaromatic copolymer resins, C5 fraction/C9 fraction copolymer resins or mixtures of these resins.

The term “terpene” groups together here, in a known way, α-pinene, β-pinene and limonene monomers; use is preferably made of a limonene monomer, a compound which exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomers are, for example: styrene, α-methyl styrene, ortho-methyl styrene, meta-methyl styrene, para-methyl styrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer resulting from a C9 fraction (or more generally from a C8 to C10 fraction).

More particularly, mention may be made of (D)CPD homopolymer resins, (D)CPD/styrene copolymer resins, polylimonene resins, limonene/styrene copolymer resins, limonene/D(CPD) copolymer resins, C5 fraction/styrene copolymer resins, C5 fraction/C9 fraction copolymer resins or mixtures of these resins.

All the above resins are well known to those skilled in the art and are commercially available, for example sold by DRT under the name “Dercolyte” as regards polylimonene resins, sold by Neville Chemical Company under the name “Super Nevtac”, by Kolon under the name “Hikorez” or by Exxon Mobil under the name “Escorez” as regards C5 fraction/styrene resins or C5 fraction/C9 fraction resins, or else by Struktol under the name “40 MS” or “40 NS” (mixtures of aromatic and/or aliphatic resins).

According to any one of the embodiments of the invention, the resin is preferentially a terpene resin such as a limonene homopolymer or copolymer or else a C5 fraction/C9 fraction copolymer.

The resin is used at a content ranging from 10 to 50 phr in the rubber composition. According to the specific embodiment in which the content of silica in the rubber composition ranges from 50 to 70 phr, the content of resin is preferably within a range extending from 20 to 40 phr.

### I-4. Liquid Plasticizer:

The liquid plasticizer preferentially has a glass transition temperature of less than −20° C., more preferentially less than −40° C.

Any extending oil, whether of aromatic or non-aromatic nature, or any liquid plasticizer known for its plasticizing properties with regard to diene elastomers, may be used as liquid plasticizer. At room temperature (23° C.), these plasticizers or these oils, which are more or less viscous, are liquids (that is to say, as a reminder, substances which have the ability to eventually take on the shape of their container), as opposed especially to plasticizing hydrocarbon-based resins which are by nature solid at room temperature.

Naphthenic oils, paraffinic oils, DAE oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, vegetable oils, ether plasticizers, ester plasticizers, phosphate plasticizers, sulphonate plasticizers and mixtures of these compounds are particularly suitable as liquid plasticizers.

### I-5. Various Additives:

The rubber compositions of the treads of the tyres in accordance with the invention may also comprise all or a portion of the usual additives customarily used in elastomer compositions intended for the manufacture of treads for tyres, especially tyres, fillers other than those mentioned above, for example non-reinforcing fillers, such as chalk, or else lamellar fillers, such as kaolin or talc, pigments, protective agents, such as antiozone waxes, chemical antiozonants, antioxidants, reinforcing resins (such as resorcinol or bismaleimide), methylene acceptors (for example, phenolic novolak resin) or methylene donors (for example, HMT or H3M), as described, for example, in application WO 02/10269, a crosslinking system based either on sulphur, or on sulphur donors and/or on peroxide and/or on bismaleimides, vulcanization accelerators or vulcanization retarders, or vulcanization activators.

These compositions may also comprise coupling activators when a coupling agent is used, agents for covering the inorganic filler or more generally processing aids capable, in a known way, by virtue of an improvement in the dispersion of the filler in the rubber matrix and of a lowering of the viscosity of the compositions, of improving their ability to be processed in the raw state; these agents are, for example, hydrolysable silanes, such as alkylalkoxysilanes, polyols, polyethers, amines, or hydroxylated or hydrolysable polyorganosiloxanes.

### I-6. Preparation of the Rubber Compositions:

The compositions used in the treads of the tyres of the invention can be manufactured in appropriate mixers, using two successive phases of preparation well known to those skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) down to a lower temperature, typically of less than 110° C., for example between 40° C. and 100° C., during which finishing phase the crosslinking system is incorporated.

The process for preparing such compositions comprises, for example, the following steps:
thermomechanically kneading (for example in one or more goes) the elastomer matrix, the reinforcing filler, the coupling agent, the hydrocarbon-based resin and if appropriate the liquid plasticizer, until a maximum temperature of between 110° C. and 190° C. is reached (“non-productive” phase);
cooling the combined mixture to a temperature of less than 100° C.;
subsequently incorporating, during a (“productive”) second step, a crosslinking system;
kneading everything up to a maximum temperature of less than 110° C.

By way of example, the non-productive phase is carried out in a single thermomechanical stage during which, in a first step, all the base constituents (the elastomer matrix, the hydrocarbon-based resin, if appropriate the liquid plasticizer, the reinforcing filler and the coupling agent) are introduced into an appropriate mixer, such as a standard internal mixer, followed, in a second step, for example after kneading for one to two minutes, by the other additives, optional additional agents for covering the filler or optional additional processing aids, with the exception of the crosslinking system. The total kneading time, in this non-productive phase, is preferably between 1 and 15 min.

After cooling the mixture thus obtained, the crosslinking system is then incorporated in an external mixer, such as an open mill, maintained at a low temperature (for example between 40° C. and 100° C.). The combined mixture is then mixed (productive phase) for a few minutes, for example between 2 and 15 min.

Irrespective of the embodiment of the invention, the crosslinking system per se is preferentially based on sulphur and on a primary vulcanization accelerator, in particular on an accelerator of the sulphenamide type. Various known secondary vulcanization accelerators or vulcanization activators, such as zinc oxide, stearic acid, guanidine derivatives (in particular diphenylguanidine), and the like, are added to this vulcanization system, being incorporated during the first non-productive phase and/or during the productive phase. The sulphur content is preferably between 0.5 and 3.0 phr and the content of the primary accelerator is preferably between 0.5 and 5.0 phr.

Use may be made, as (primary or secondary) accelerator, of any compound capable of acting as accelerator of the vulcanization of diene elastomers in the presence of sulphur, especially accelerators of the thiazole type and their derivatives and accelerators of the thiuram and zinc dithiocarbamate types. These accelerators are more preferentially selected from the group consisting of 2-mercaptobenzothiazole disulphide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-(tert-butyl)-2-benzothiazolesulphenamide (abbreviated to “TBBS”), N-(tert-butyl)-2-benzothiazolesulphenimide (abbreviated to “TBSP”), zinc dibenzyldithiocarbamate (abbreviated to “ZBEC”) and the mixtures of these compounds. Preferably, a primary accelerator of the sulphenamide type is used.

The final composition thus obtained can subsequently be calendered or extruded, for example to form a rubber profiled element used in the manufacture of a tyre tread, in particular for a passenger vehicle.

The invention relates to the treads described above, both in the raw state (that is to say, before curing) and in the cured state (that is to say, after crosslinking or vulcanization).

The invention also relates to a process for preparing the tread in accordance with the invention, which process comprises the following steps:
thermomechanically kneading the elastomer matrix, the reinforcing filler, the coupling agent and the hydrocarbon-based resin until a maximum temperature of between 110° C. and 190° C. is reached;
cooling the combined mixture to a temperature of less than 100° C.;
subsequently incorporating, during a second step, a crosslinking system;
kneading everything up to a maximum temperature of less than 110° C.;
calendering or extruding the composition thus obtained.

The invention also applies to the cases where the rubber compositions described above form only a portion of treads of the composite or hybrid type, in particular those consisting of two radially superimposed layers of different formulations (“cap-base” structure), both being patterned and intended to come into contact with the road when the tyre is rolling, during the life of the latter. The base part of the formulation described above can then constitute the radially outer layer of the tread intended to come into contact with the ground from the moment when the new tyre starts rolling, or on the other hand its radially inner layer intended to come into contact with the ground at a later stage.

The abovementioned characteristics of the present invention, and also others, will be better understood on reading the following description of exemplary embodiments of the invention, given by way of nonlimiting illustration.

### II. EXEMPLARY EMBODIMENTS OF THE INVENTION

### II.1—Preparation of Compositions A, B, C and D:

The formulations (in phr) of the compositions A, B, C and D are described in Table I. The elastomer matrices of compositions A and C are identical and comprise more than 50% by weight of a solution SBR which bears a silanol function at the chain end. The elastomer matrices of compositions B and D are identical and comprise more than 50% by weight of a solution SBR devoid of silanol function.

Compositions C and D differ from one another solely by the nature of the elastomer which constitutes the elastomer matrix. Composition C is in accordance with the invention while composition D is not, due to the nature of the elastomer matrix.

Compositions A and B differ from one another solely by the nature of the elastomer which constitutes the elastomer matrix and are both not in accordance with the invention, due to the content of reinforcing filler, the content of silica, the content of resin and the content of liquid plasticizer.

These compositions are manufactured in the following manner: the elastomer matrix, the reinforcing filler, the coupling agent, the hydrocarbon-based resin, where appropriate the liquid plasticizer, and also the various other ingredients, with the exception of the vulcanization system, are successively introduced into an internal mixer (final degree of filling: around 70% by volume), the initial vessel temperature of which is approximately 60° C. Thermomechanical working (non-productive phase) is then carried out in one step, which lasts in total 5 min, until a maximum “dropping” temperature of 165° C. is reached.

The mixture thus obtained is recovered and cooled and then sulphur and an accelerator of sulphenamide type are incorporated on a mixer (homofinisher) at 23° C., everything being mixed (productive phase) for an appropriate time (for example between 5 and 12 min).

Compositions A, B, C and D thus obtained are vulcanized, and their properties in the cured state are given in Table I.

### II.2—Results:

The dynamic properties are measured on a viscosity analyser (Metravib VA4000) according to Standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz.

To measure tan delta max at 23° C., a strain amplitude sweep is carried out at 23° C. from 0% to 50% (forward cycle) and then from 50% to 0% (return cycle). For the return cycle, the maximum value of tan(δ) observed, tan(δ)max, is measured. The lower the value of tan(δ)max at 23° C., the lower the rolling resistance, which indicates good rolling resistance performance of the tyre.

To measure the complex shear modulus G*, a temperature sweep under a fixed stress of 0.7 MPa is carried out.

The tensile tests are carried out in accordance with French standard NF T 46-002 of September 1988. The nominal secant modulus is measured in second elongation (that is to say after accommodation), calculated relative to the initial cross section of the test specimen (or apparent stress in MPa at 100% elongation, denoted ASM100).

All these tensile measurements are carried out under normal conditions of temperature (23±2° C.) and hygrometry (50±5% relative humidity), according to French standard NF T 40-101 (December 1979).

All the values are indicated relative to a base 100 in relation to a given control. A value greater than 100 indicates a value greater than that of the control. Composition C in accordance with the invention has composition D not in accordance as control. Composition B not in accordance with the invention has composition A not in accordance as control.

The tan(δ)max values at 23° C. for compositions B and D comprising the solution SBR bearing a silanol function at the chain end are much lower than compositions A and C, respectively, as is expected.

Unexpectedly, it is observed that the ASM100 value is lower by 16% for composition D than for composition C, which means that the rubber composition D is softer, therefore more deformable than composition C, which is more favourable for the grip performance of the tyre by better contact with the ground on which the tyre is running, when a composition of this type is used as tyre tread. This result is obtained without a reduction in the G* value, which suggests maintenance of the road handling of the tyre. The improvement in this compromise between the hysteresis properties and the deformation of the rubber composition is not observed in the case of composition A compared to composition B. A tyre, the tread of which consists of composition D, has an improved performance compromise between rolling resistance and grip.

TABLE I

| Compositions | A | B | C | D |
|---|---|---|---|---|
| SBR1 (1) | 100 | — | 100 | — |
| SBR2 (2) | — | 100 | — | 100 |
| Carbon black (3) | 3 | 3 | 3 | 3 |
| Silica (4) | 80 | 80 | 60 | 60 |
| Resin (5) | 36 | 36 | 30 | 30 |
| Liquid plasticizer (6) | 7 | 7 | — | — |
| Antiozone wax | 1.8 | 1.8 | 1.8 | 1.8 |
| Antioxidant (7) | 2.7 | 2.7 | 2.7 | 2.7 |
| Silane (8) | 6.4 | 6.4 | 4.8 | 4.8 |
| Stearic acid | 2 | 2 | 2 | 2 |
| CBS (9) | 2.3 | 2.3 | 2.3 | 2.3 |
| DPG (10) | 2 | 2 | 2 | 2 |
| Sulphur | 1 | 1 | 1 | 1 |
| ZnO | 1 | 1 | 1 | 1 |
| Properties in the cured state | | | | |
| Tan delta max 23° C. | 100 | 78 | 100 | 72 |
| MSA 100 23° C. | 100 | 108 | 100 | 84 |
| G* 60° C., 0.7 MPa | 100 | 109 | 100 | 100 |

(1) SBR1: SBR with 27% of styrene units and 24% of 1,2- units of the butadiene part (Tg = −48° C.);
(2) SBR with 27% of styrene units and 24% of 1,2- units of the butadiene part (Tg = −48° C.) bearing a silanol function at the elastomer chain end;
(3) ASTM grade N234 (Cabot);
(4) Silica: Zeosil 1165 MP from Rhodia (HDS type);
(5) C5 fraction/C9 fraction resin: ECR-373 from Exxon;
(6) Sunflower oil comprising 85% by weight of oleic acid, Lubrirob Tod 1880 from Novance;
(7) N-(1,3-dimethylbutyl)-N′-phenyl-p-phenylenediamine, from Flexsys;
(8) TESPT (Si69 from Degussa);
(9) N-cyclohexyl-2-benzothiazolesulphenamide (Santocure CBS from Flexsys);
(10) Diphenylguanidine (Perkacit DPG from Flexsys).

1.-10. (canceled)

11. A tire comprising a tread which comprises a rubber composition based on at least:
an elastomer matrix comprising more than 50% by weight of a solution SBR bearing a silanol function at the chain end,
a reinforcing filler present at a content of between 40 and 80 phr, which reinforcing filler comprises between 40 and 80 phr of a silica,
a coupling agent for coupling the silica to the solution SBR,
10 to 50 phr of a hydrocarbon-based resin having a Tg of greater than 20° C., and
0 to less than 5 phr of a liquid plasticizer.

12. The tire according to claim 11, wherein the solution SBR has a glass transition temperature of less than −40° C.

13. The tire according to claim 12, wherein the solution SBR has a glass transition temperature of between −70° C. and −40° C.

14. The tire according to claim 11, wherein the elastomer matrix comprises more than 75% by weight of solution SBR.

15. The tire according to claim 14, wherein the elastomer matrix comprises more than 85% by weight of solution SBR.

16. The tire according to claim 11, wherein the hydrocarbon-based resin is a terpene resin or a C5 fraction/C9 fraction copolymer.

17. The tire according to claim 11, wherein the content of silica ranges from 50 to 70 phr.

18. The tire according to claim 17, wherein the content of hydrocarbon-based resin ranges from 20 to 40 phr.

19. The tire according to claim 17, wherein the content of reinforcing filler varies between 50 phr and 75 phr.

20. The tire according to claim 11, wherein the reinforcing filler comprises a carbon black at a content of less than 10 phr.

21. The tire according to claim 20, wherein the reinforcing filler comprises a carbon black at a content of at most 5 phr.

22. A process for preparing a tire according to claim 11 comprising the steps of:
thermomechanically kneading the elastomer matrix, the reinforcing filler, the coupling agent and the hydrocarbon-based resin until a maximum temperature of between 110° C. and 190° C. is reached thereby forming a combined mixture;
cooling the combined mixture to a temperature of less than 100° C.;
subsequently incorporating a crosslinking system;
kneading the combined mixture and the crosslinking system up to a maximum temperature of less than 110° C. thereby forming a composition; and
calendering or extruding the composition.
